(19) United States
(12) Patent Application Publication
(10) Pub. No.: US 2009/0259673 A1
(43) Pub. Date: Oct. 15, 2009

(54) METHOD AND APPARATUS FOR EXTRACTING TEXT FROM INTERNET MAIL ATTACHMENT FILE

(76) Inventors: Young Han CHOI, Daejeon (KR); In Sook JANG, Daejeon (KR); Hyung Geun OH, Daejeon (KR); Do Hoon LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/194,600

(22) Filed: Aug. 20, 2008

(30) Foreign Application Priority Data
Apr. 14, 2008 (KR) 10-2008-0034302

(51) Int. Cl. G06F 17/30

(52) U.S. Cl. 707/100; 707/E17.009

(57) ABSTRACT

Provided are a method and apparatus for extracting text from an Internet mail attachment file. The apparatus includes a mail display unit for displaying Internet mail and an attachment file received from outside, an attachment file storage for storing the attachment file, a text extraction engine for extracting a text code included in the attachment file, and an attachment file text extractor for extracting text included in the attachment file using the text extraction engine.

### CROSS-REFERENCE TO RELATED APPLICATION

This application claims priority to and the benefit of Korean Patent Application No. 2008-34302, filed Apr. 14, 2008, the disclosure of which is incorporated herein by reference in its entirety.

### BACKGROUND

1. Field of the Invention

The present invention relates to a method and apparatus for extracting text from an Internet mail attachment file, and more particularly, to a method and apparatus for extracting only text content from a file attached to Internet mail without executing the attachment file and checking the content in advance.

2. Discussion of Related Art

With the development of Internet technology and computer technology, important information is electronically stored in computer systems, and important documents are frequently transferred via the Internet in the form of files.

Meanwhile, many Internet viruses and malicious codes that use personal information by stealth or damage stored important documents are transferred by Internet mail.

Most malicious codes are transferred by Internet mail in the form of attachment files and automatically infect a computer when its user opens the file out of curiosity.

In particular, attachment files including such malicious codes have very important or interesting file names to psychologically induce a user to execute them.

Here, if it is possible to know the content of an attachment file without executing it, damage caused by such psychological tricks can be remarkably reduced.

However, conventional Internet firewalls, etc., classify received Internet mail according to the content of the mail only, and thus cannot distinguish mail including a malicious code or other mail on the basis of the content of an attachment file.

### SUMMARY OF THE INVENTION

The present invention is directed to providing a method and apparatus for extracting text from a file attached to Internet mail without executing the attachment file.

The present invention is also directed to providing a method and apparatus for extracting text from a file attached to Internet mail without executing the attachment file and automatically classifying the mail.

One aspect of the present invention provides an apparatus for extracting text from an Internet mail attachment file, comprising: a mail display unit for displaying Internet mail and an attachment file received from outside; an attachment file storage for storing the attachment file; a text extraction engine for extracting a text code included in the attachment file; and an attachment file text extractor for extracting text included in the attachment file using the text extraction engine.

The text extraction engine may include one of an engine extracting text from an attachment file based on Compound Document Format (CDF) and an engine extracting text from an attachment file based on Extensible Markup Language (XML). The apparatus may further comprise an Internet mail classifier for classifying the Internet mail using the text extracted by the attachment file text extractor.

The engine extracting text from an XML-based attachment file may analyze a schema of the attachment file, analyze a tag of the attachment file on the basis of the analyzed schema, search for a tag including the text code using the analyzed tag and analyze the searched tag to extract the text code included in the attachment file. The engine extracting text from a CDF-based attachment file may analyze a storage and streams of the attachment file, search for a stream including text among the streams and analyze the stream to extract the text code included in the attachment file.

The attachment file text extractor may analyze the text code extracted by the text extraction engine and a code page of the attachment file, and extract the text from the text code according to the code page. The attachment file text extractor may extract the text from the text code according to American Standard Code for Information Interchange (ASCII) code when the text code extracted by the text extraction engine is a one-byte character code. The mail display unit may display the text extracted by the attachment file extractor together with the Internet mail.

Another aspect of the present invention provides a method of extracting text from a file attached to Internet mail, comprising: selecting a text extraction method corresponding to a file attached to Internet mail received from outside; extracting a text code included in the attachment file according to the selected text extraction method; and generating text corresponding to the extracted text code.

When the attachment file is based on CDF, the extracting of the text code may comprise: analyzing a storage and streams of the attachment file; searching for a stream including text among the streams; and analyzing the stream to extract the text code included in the attachment file. When the attachment file is based on XML, the extracting of the text code may comprise: analyzing a schema of the attachment file; analyzing a tag of the attachment file on the basis of the analyzed schema; searching for a tag including the text code using the analyzed tag; and analyzing the searched tag to extract the text code included in the attachment file.

The selecting of the text extraction method may comprise: receiving the Internet mail from outside; determining whether or not the received Internet mail has an attachment file; and when the Internet mail does have an attachment file, determining whether or not text of the attachment file can be extracted according to a previously determined text extraction method. The method may further comprise: selecting and displaying a part of the generated text. The method may further comprise: determining whether or not the generated text contains a previously set classification keyword; and when the generated text contains the previously set classification keyword, moving the Internet mail and the attachment file to a mail directory corresponding to the classification keyword. The attachment file may be one of a word processor file of Haansoft company, a word processor file of Microsoft corporation, a spreadsheet file of Microsoft corporation, and a presentation file of Microsoft corporation.

The generating of the text corresponding to the extracted text code may comprise: analyzing a code page of the attachment file including the extracted text code; and extracting the text from the text code according to the code page of the attachment file. When the extracted text code is a one-byte character code, the text may be extracted from the text code according to ASCII code.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of an apparatus for extracting text from an Internet mail attachment file according to an exemplary embodiment of the present invention;

FIG. 2 is a flowchart showing a method of extracting text from an Internet mail attachment file according to an exemplary embodiment of the present invention;

FIG. 3 illustrates an example of a method of extracting text from an Internet mail attachment file according to an exemplary embodiment of the present invention;

FIG. 4 is a flowchart showing a method of extracting text from an Internet mail attachment file according to another exemplary embodiment of the present invention;

FIG. 5 illustrates structures of file formats from which text of an attachment file can be extracted according to an exemplary embodiment of the present invention;

FIG. 6 is a flowchart showing a text extraction method of an extraction engine for extracting text from a Compound Document Format (CDF)-based file; and

FIG. 7 is a flowchart showing a text extraction method of an extraction engine for extracting text from an Extensible Markup Language (XML)-based file.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

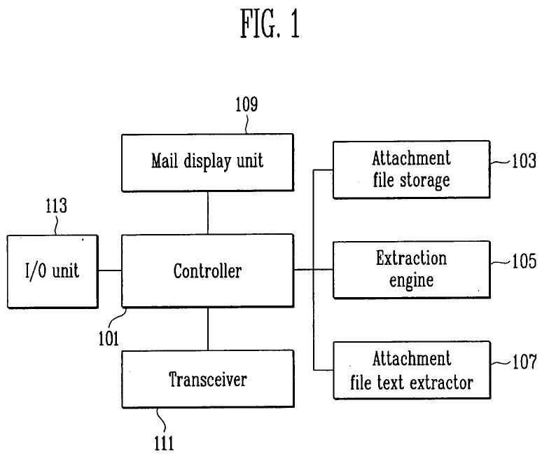

FIG. 1 is a block diagram of an apparatus for extracting text from an Internet mail attachment file according to an exemplary embodiment of the present invention.

Referring to FIG. 1, the apparatus for extracting text from an Internet mail attachment file includes an Input/Output (I/O) unit 113, a controller 101, an attachment file storage 103, an extraction engine 105, an attachment file text extractor 107, a mail display unit 109 and a transceiver 111.

The I/O unit 101 is connected with an input device, such as a keyboard or mouse, receiving a command from a user, and an output device, such as a monitor.

The controller 101 manages overall functioning of the apparatus for extracting text from an Internet mail attachment file according to an exemplary embodiment of the present invention. More specifically, the controller 101 controls the extraction engine 105 to extract text from an attachment file and output the result.

The attachment file storage 103 functions to store Internet mail and attachment files received from outside through the transceiver 111.

The extraction engine 105 functions to extract a text code from the attachment file stored in the attachment file storage 103. The extraction engine 105 may vary according to the type of an attachment file. For example, an engine extracting a text code from “MS Word” word processor program of Microsoft Corporation may be different from an engine extracting a text code from “Hangul” word processor program of Haansoft company. Therefore, there may be as many extraction engines 105 as there are types of text-extractable files previously determined, according to an exemplary embodiment of the present invention.

The attachment file text extractor 107 functions to apply the extraction engine 105 to an attachment file and extract text from the attachment file. The attachment file text extractor 107 is controlled by the controller 101 to select an appropriate one of the extraction engines 105 and extracts the text from the attachment file. More specifically, the attachment file text extractor 107 generates the text using a text code extracted by the extraction engine 105.

The mail display unit 109 functions to display received Internet mail together with a text document extracted by the attachment file text extractor 107.

Meanwhile, when mail must be automatically classified according to the content of an attachment file, the apparatus may further include a mail classifier (not shown) controlled by the controller 101 to automatically classify mail.

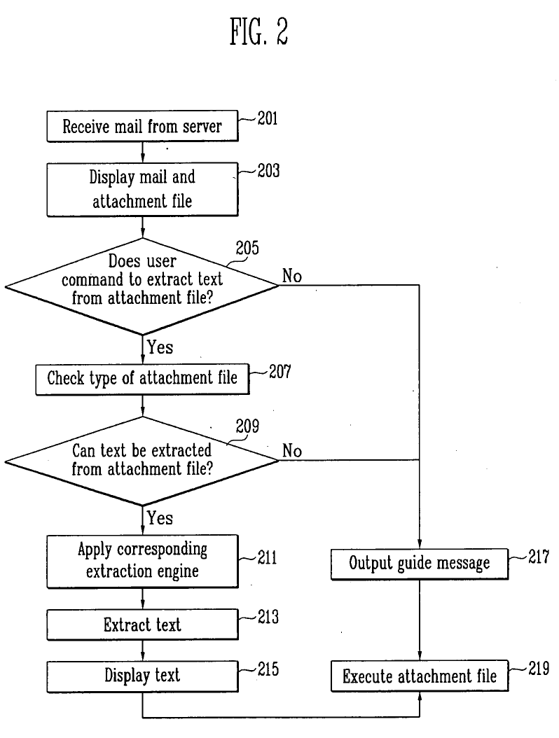

FIG. 2 is a flowchart showing a method of extracting text from an Internet mail attachment file according to an exemplary embodiment of the present invention.

Referring to FIG. 2, Internet mail and a file attached to the mail are received from an external mail server (step 201). Then, a mail display unit displays the Internet mail and the presence of an attachment file (step 203). Here, when a user commands to extract text from the attachment file (step 205), the type of the file attached to the Internet mail is checked (step 207), and it is checked whether or not text can be extracted from the attachment file (step 209).

Here, the attachment file may be a word processor file, a spreadsheet file, etc., and generally may be based on Compound Document Format (CDF) or Extensible Markup Language (XML). To determine whether or not text can be extracted from the attachment file, the extension of the attachment file may be checked, or the constitution of the attachment file may be analyzed.

When text can be extracted from the attachment file, an appropriate one of previously stored extraction engines for the attachment file is applied to the attachment file (step 211), and text is extracted from the attachment file using the extraction engine (step 213).

Subsequently, a text document is displayed on a screen (step 215). Here, the text document may be displayed using a program corresponding to a document format generated by the method according to an exemplary embodiment of the present invention, or a basic text editor, such as “Notepad”.

Finally, when the user checking the displayed text document commands to execute the attachment file, the attachment file is executed (step 219).

Meanwhile, when the user directly executes the attachment file without commanding to extract text of the attachment file in step 205, or it is checked in step 209 that text cannot be extracted from the attachment file, a guide message is output (step 217), and then the attachment file is executed as requested by the user (step 219).

According to an exemplary embodiment of the present invention performed through these steps, when a malicious code or computer virus is included in a file attached to Internet mail, a user can check the content of the attachment file without executing the file, such that the danger of exposure to malicious codes can be minimized.

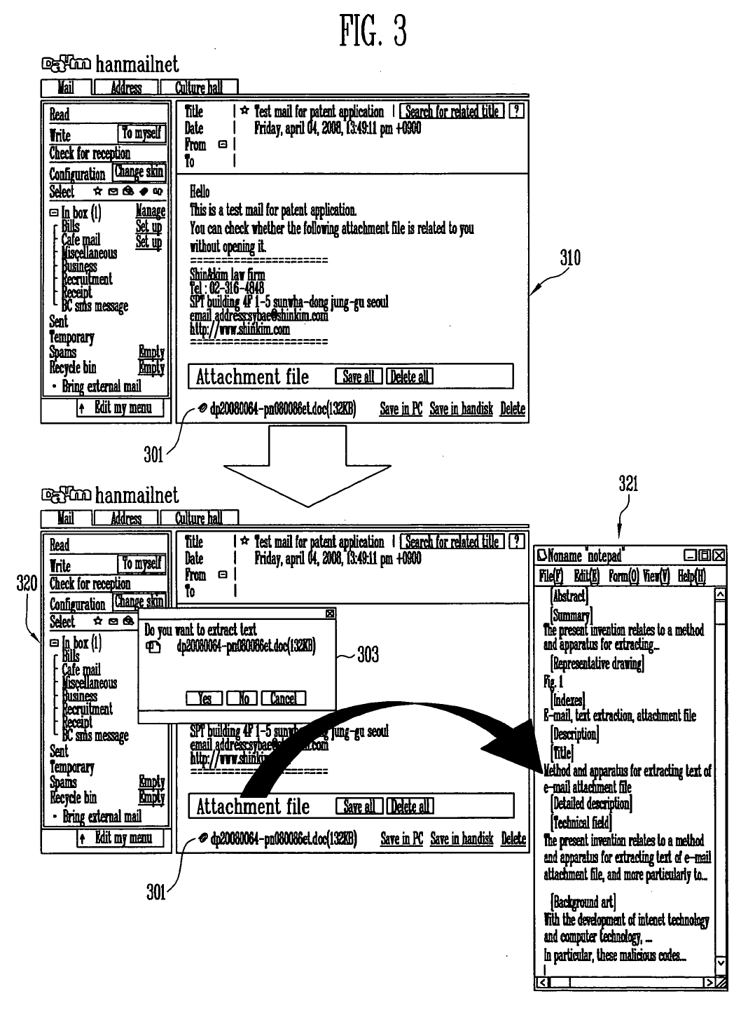

FIG. 3 illustrates an example of a method of extracting text from an Internet mail attachment file according to an exemplary embodiment of the present invention.

Reference numeral 310 denotes a general Internet mail message.

In general, such an Internet mail message does not directly display the content of an attachment file 301 but only indicates that the attachment file 301 exists, as indicated by reference numeral 310.

When a user clicks the attachment file 301 to execute it, a pop-up window 303 asking whether or not to extract the text of the attachment file 301 may appear.

When it is selected in the pop-up window 303 to extract the text, the text alone is extracted from the attachment file 301 and separately displayed without executing the attachment file 301, as indicated by reference numeral 320. The extracted text content may be displayed by a text display program corresponding to an exemplary embodiment of the present invention, or a basic text editor program, such as “Notepad”. Here, when an attachment file contains a large amount of content, only a necessary part of the content may be displayed. For example, only a page including a previously set specific keyword or text corresponding to the first page may be displayed.

On the basis of the text content extracted in this way, it is possible to determine whether or not a received attachment file is actually necessary for a user without executing the attachment file. Therefore, malicious codes or virus programs spread via attachment files can be effectively prevented.

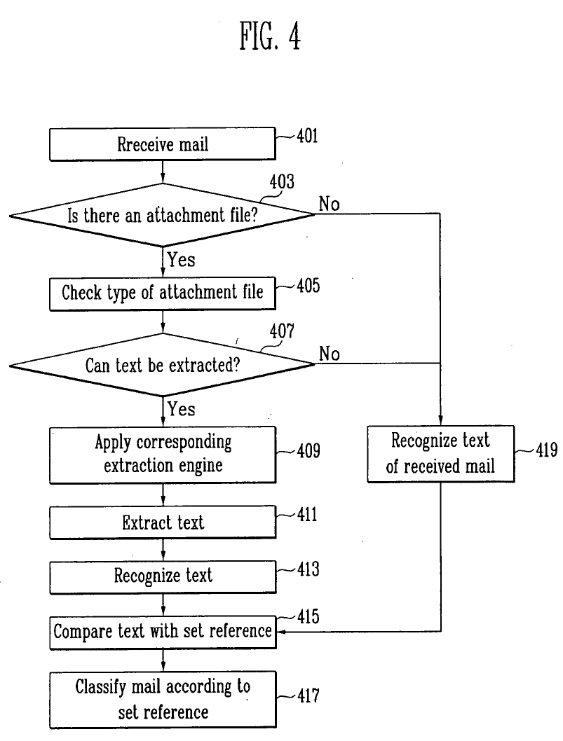

FIG. 4 is a flowchart showing a method of extracting text from an Internet mail attachment file according to another exemplary embodiment of the present invention.

FIG. 4 illustrates a method of automatically analyzing an attachment file and classifying received Internet mail according to a specific keyword. There has been a conventional method of classifying received Internet mail according to a specific keyword, but no method of classifying mail according to a keyword included in an attachment file. According to an exemplary embodiment of the present invention, it is possible to automatically classify mail on the basis of a keyword of an attachment file.

When Internet mail is received from an external mail server (step 401), it is checked whether or not there is an attachment file (step 403). When there is an attachment file, the type of the attachment file is checked (step 405), and it is determined whether or not text can be extracted from the attachment file (step 407). Here, when text can be extracted from the attachment file, an appropriate text extraction engine is applied to the attachment file (step 409), text is extracted from the attachment file (step 411), and then the content of the extracted text is recognized (step 413). The recognized text is compared with a previously determined keyword, which is a classification reference, (step 415), and the received Internet mail is automatically classified according to the set reference (step 417).

Meanwhile, when it is checked in step 403 that there is no attachment file, or it is determined in step 407 that text cannot be extracted from the attachment file, the text of the received Internet mail is recognized (step 419), and the recognized text of the Internet mail is compared with the previously determined keyword, which is a classification reference (step 415). Then, the received Internet mail is automatically classified according to the set reference (step 417).

According to the above described method, Internet mail can be classified according to the content of an attachment file as well as the content of the mail. Thus, it is possible to automatically classify Internet mail into spam mail, advertisement mail, mail including an important attachment file, and so on.

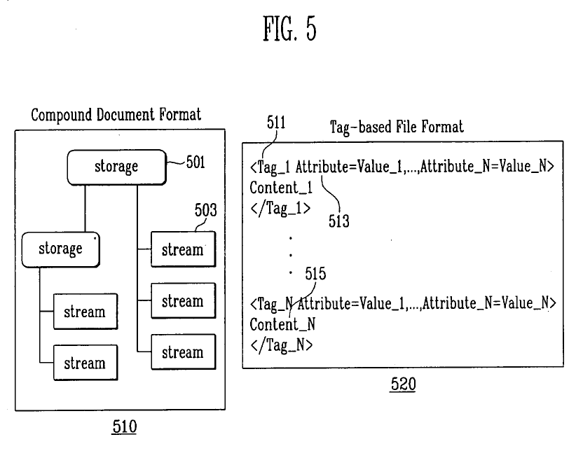

FIG. 5 illustrates structures of file formats from which text of an attachment file can be extracted according to an exemplary embodiment of the present invention.

Referring to FIG. 5, reference numeral 510 denotes the structure of CDF from which text is extracted according to an exemplary embodiment of the present invention. CDF consists of storages 501 and streams 503. The storages 501 function as folders of “Windows Explorer”, and the streams 503 function as files. In other words, the storages 501 designate the locations of file contents, and the streams 503 have the necessary file contents separated according to functions.

Reference numeral 520 denotes the structure of an XML-based file format.

The XML-based file format is designed on the basis of the XML structure. Therefore, the XML-based file format consists of tags 511 indicating a file structure, attributes 513 by which various characteristics of each tag are set, and contents 515 indicating actual contents.

In particular, the XML-based file format has a schema indicating its basic structure, and functions performed by the respective tags 511 are defined by the schema.

In other words, by analyzing the schema, it is possible to know which one of the tags 511 includes text.

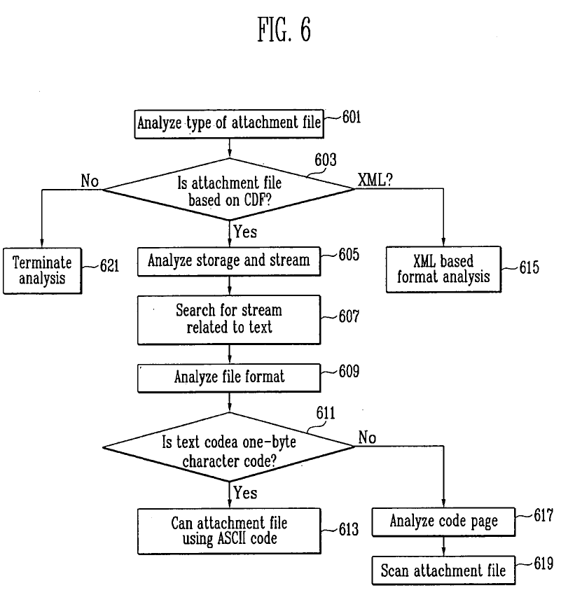

FIG. 6 is a flowchart showing a text extraction method of an extraction engine for extracting text from a CDF-based file.

Referring to FIG. 6, the type of an attachment file is analyzed (step 601). According to an exemplary embodiment of the present invention, the types of files from which text can be extracted are previously determined. Thus, the type of an attachment file is analyzed to determine whether or not an exemplary embodiment of the present invention can be applied to the file. By checking the extension of the attachment file, it is possible to classify the type of the file.

Subsequently, it is determined whether or not the attachment file is based on CDF (step 603). This is because different text extraction engines are applied according to the different types of attachment files.

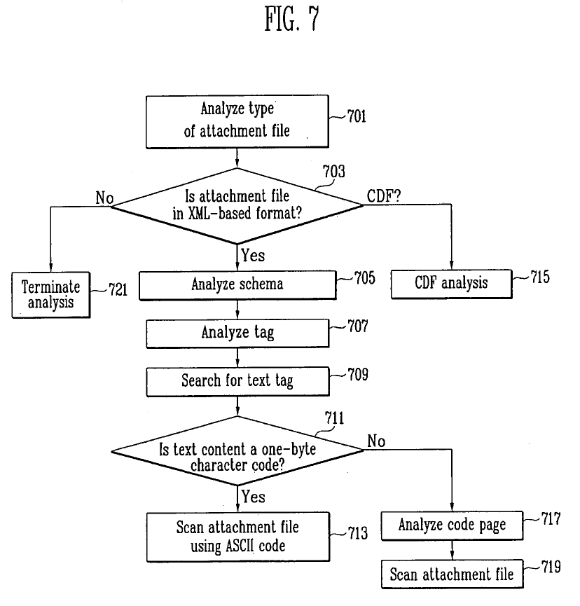

When the attachment file is in the XML-based file format other than CDF, it is analyzed according to the XML-based file format (step 615). When the attachment file is not based on either CDF or XML, the analysis is terminated (step 621). A method of extracting text from an XML-based file will be described in detail with reference to FIG. 7.

When the attachment file is based on CDF, a text extraction engine according to CDF is used. Since the CDF-based file has the structure indicated by reference numeral 510 of FIG. 5, the text extraction engine first analyzes a storage and the stream structure of the attachment file (step 605). Subsequently, a stream related to text content is searched among streams (step 607), and the stream is analyzed according to the file format (step 609). When the file is based on CDF, the stream related to text is not only searched for and extracted, but also analyzed according to the file format to extract a text code. In other words, all the CDF-based files cannot be extracted by one text extraction engine, but require different text extraction engines according to known file formats.

For example, “PowerPoint” files of Microsoft Corporation are based on CDF, and the text of a “PowerPoint” file is stored in “PowerPoint Document” stream. To extract the text from the stream, the stream must be analyzed. A “PowerPoint” file is stored in a stream in record units, and a record related to text is “SlideListWithText”. Therefore, a “PowerPoint” file requires an engine to analyze the record and extract text.

After the file format is analyzed, it is determined whether or not the analyzed text code is a one-byte character code (step 611). When the text code is a one-byte character code, the file is scanned using American Standard Code for Information Interchange (ASCII) code to extract text (step 613).

Meanwhile, when the text code analyzed in step 611 is not a one-byte character code, the code page of the file is analyzed (step 617). Then, the file is scanned according to the text code to extract text (step 619).

FIG. 7 is a flowchart showing a text extraction method of an extraction engine for extracting text from an XML-based file.

Referring to FIG. 7, the type of an attachment file is analyzed (step 701). According to an exemplary embodiment of the present invention, the types of files from which text can be extracted are previously determined. Thus, the type of an attachment file is analyzed to determine whether or not an exemplary embodiment of the present invention can be applied to the file. By checking the extension of the attachment file, it is possible to classify the type of the file.

Subsequently, it is determined whether or not the attachment file is in XML-based file format (step 703).

When the attachment file is based on CDF other than XML, it is analyzed according to the steps described with reference to FIG. 6 (step 715). When the attachment file is not based on either CDF or XML, the analysis is terminated (step 721).

When the attachment file is based on XML, a text extraction engine according to XML is used. Here, the schema of the attachment file is first analyzed (step 705). In the XML-based file, a function performed by each tag varies according to schemas, as described with reference to FIG. 5. Thus, the text extraction engine analyzes the schema to check which tag includes text data.

Subsequently, a tag of the file is analyzed on the basis of the analyzed schema (step 707). Since the function of the tag varies according to characteristics of the schema, the function of each tag used in the file is analyzed on the basis of the analyzed schema.

Then, a tag related to the text content is searched for (step 709). It is checked whether or not content included in a searched tag related to the text content is a one-byte character (step 711). When the content is a one-byte character, the file is scanned according to ASCII code to extract text (step 713). When the content is a two-byte character, a code page is analyzed (step 717), and the file is scanned according to the analyzed code to extract text (step 719).

The present invention can provide a method and apparatus for extracting text from a file attached to Internet mail without executing the attachment file.

In addition, the present invention can provide a method and apparatus for extracting text from a file attached to Internet mail without executing the attachment file and automatically classifying the mail

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for extracting text from an Internet mail attachment file, comprising:
a mail display unit for displaying Internet mail and an attachment file received from outside;
an attachment file storage for storing the attachment file;
a text extraction engine for extracting a text code included in the attachment file; and
an attachment file text extractor for extracting text included in the attachment file using the text extraction engine.

2. The apparatus of claim 1, wherein the text extraction engine includes one of an engine extracting text from an attachment file based on Compound Document Format (CDF) and an engine extracting text from an attachment file based on Extensible Markup Language (XML).

3. The apparatus of claim 1, further comprising:
an Internet mail classifier for classifying the Internet mail using the text extracted by the attachment file text extractor.

4. The apparatus of claim 2, wherein the engine extracting text from an XML-based attachment file analyzes a schema of the attachment file, analyzes a tag of the attachment file on the basis of the analyzed schema, searches for a tag including the text code using the analyzed tag, and analyzes the searched tag to extract the text code included in the attachment file.

5. The apparatus of claim 2, wherein the engine extracting text from a CDF-based attachment file analyzes a storage and streams of the attachment file, searches for a stream including text among the streams, and analyzes the stream to extract the text code included in the attachment file.

6. The apparatus of claim 1, wherein the attachment file text extractor analyzes the text code extracted by the text extraction engine and a code page of the attachment file, and extracts the text from the text code according to the code page.

7. The apparatus of claim 6, wherein the attachment file text extractor extracts the text from the text code according to American Standard Code for Information Interchange (ASCII) code when the text code extracted by the text extraction engine is a one-byte character code.

8. The apparatus of claim 1, wherein the mail display unit displays the text extracted by the attachment file extractor together with the Internet mail.

9. A method of extracting text from a file attached to Internet mail, comprising:
selecting a text extraction method corresponding to a file attached to Internet mail received from outside;
extracting a text code included in the attachment file according to the selected text extraction method; and
generating text corresponding to the extracted text code.

10. The method of claim 9, wherein when the attachment file is based on Compound Document Format (CDF), the extracting of the text code comprises:
analyzing a storage and streams of the attachment file;
searching for a stream including text among the streams; and
analyzing the stream to extract the text code included in the attachment file.

11. The method of claim 9, wherein when the attachment file is based on Extensible Markup Language (XML), the extracting of the text code comprises:
analyzing a schema of the attachment file;
analyzing a tag of the attachment file on the basis of the analyzed schema;
searching for a tag including the text code using the analyzed tag; and
analyzing the searched tag to extract the text code included in the attachment file.

12. The method of claim 9, wherein the selecting of the text extraction method comprises:
receiving the Internet mail from outside;
determining whether or not the received Internet mail has an attachment file; and
when the Internet mail does have an attachment file, determining whether or not text of the attachment file can be extracted according to a previously determined text extraction method.

13. The method of claim 9, further comprising:
selecting and displaying a part of the generated text.

14. The method of claim 9, further comprising:
determining whether or not the generated text contains a previously set classification keyword; and
when the generated text contains the previously set classification keyword, moving the Internet mail and the attachment file to a mail directory corresponding to the classification keyword.

15. The method of claim 9, wherein the attachment file is one of a word processor file of Haansoft company, a word processor file of Microsoft corporation, a spreadsheet file of Microsoft corporation and a presentation file of Microsoft corporation.

16. The method of claim 9, wherein the generating of the text corresponding to the extracted text code comprises:
analyzing a code page of the attachment file including the extracted text code; and
extracting the text from the text code according to the code page of the attachment file.

17. The method of claim 16, wherein when the extracted text code is a one-byte character code, the text is extracted from the text code according to American Standard Code for Information Interchange (ASCII) code.
